(19) United States
(12) Patent Application Publication
(10) Pub. No.: US 2006/0123242 A1
(43) Pub. Date: Jun. 8, 2006

(54) Biometric security device

(75) Inventor: Ralph Merrem, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ACCO Brands USA, LLC, Lincolnshire, IL (US)

(21) Appl. No.: 11/231,633

(22) Filed: Sep. 20, 2005

Related U.S. Application Data
(60) Provisional application No. 60/612,280, filed on Sep. 21, 2004.

(51) Int. Cl. H04K 1/00; H04L 9/00

(52) U.S. Cl. 713/186

(57) ABSTRACT

A security system configured to secure a portable electronic device is provided. The system includes a biometric device configured to receive a biometric identification from a user. The biometric identification may be received by, for example, scanning a fingerprint or iris of a user. Other biometric identifications may also be appreciated. The biometric device is configured to determine a verification result based on the received biometric identification. The verification may be performed by comparing the received biometric identification with a stored biometric identification for the user. The biometric device may then send a verification result through a wireless connection to a wireless module. The wireless module is then configured to automatically actuate a security device to lock/ unlock the security device to/from the portable electronic device. For example, if a spindle of the security device is inserted in the portable electronic device, the spindle and security device may be unlocked/locked from/to the portable electronic device.

### CROSS-REFERENCE TO RELATED APPLICATIONS

This application claims priority to co-pending U.S. Provisional Patent Application No. 60/612,280, filed on Sep. 21, 2004, which is hereby incorporated by reference, as if set forth in full in this document, for all purposes.

### BACKGROUND OF THE INVENTION

Embodiments of the present invention generally relate to security devices and more specifically to biometric security systems.

A user may have many different portable electronic devices. These devices are typically small, but very expensive. When left unattended, portable electronic devices can be stolen.

Conventional security devices that are used to secure portable electronic devices may be locked using a key and/or combination. The key is inserted into a lock and used to unlock or lock the security device. However, the key or combinations may be compromised. For example, the key may be lost or stolen. Further, a combination for a combination lock may also be lost, forgotten, or stolen. If a user loses/forgets a key or combination for a lock, the security device may be no longer useable. If a key or combination is stolen, a thief can steal the portable electronic device.

### BRIEF SUMMARY OF THE INVENTION

Embodiments of the present invention generally relate to a biometric security system.

In one embodiment, a security system configured to secure a portable electronic device is provided. The system includes a biometric device configured to receive a biometric identification from a user. The biometric identification may be received by, for example, scanning a fingerprint or iris of a user. Other biometric identifications may also be appreciated. The biometric device is configured to determine a verification result based on the received biometric identification. The verification may be performed by comparing the received biometric identification with a stored biometric identification for the user.

In some embodiments, the biometric device may then send a verification result through a wireless connection to a wireless module. The wireless module is then configured to automatically actuate a security device to lock or unlock the security device so that the security device can be attached to or separated from the portable electronic device. For example, if a slot engagement member of the security device is inserted in the portable electronic device, the slot engagement member and security device may be unlocked/locked from/to the portable electronic device.

In one embodiment, a biometric security system for securing a portable electronic device including a slot associated with the portable electronic device is provided. The biometric security system comprises: a security device including a slot engagement member, wherein the slot engagement member is sized to enter the slot; a biometric device configured to receive a biometric identification from a user and configured to determine a verification result based on received biometric identification with a stored biometric identification for the user, wherein the biometric device is operatively coupled to the security device; and a transducer operatively coupled to the security device and the biometric device, wherein the transducer is capable of actuating the slot engagement member.

In another embodiment, a method for securing a portable electronic device is provided. The method comprises: receiving a biometric identification from a user; verifying the biometric identification; and after verifying the biometric identification, moving a slot engagement member within a slot associated with the portable electronic device such that the slot engagement member cannot be withdrawn from the slot.

In yet another embodiment, a system is provided, the system comprising: a portable electronic device including a security slot associated with the portable electronic device; a security device configured to attach to the portable electronic device via the security slot; and a biometric device configured to receive a biometric identification from a user and configured to determine a verification result based on received biometric identification with a stored biometric identification for the user, wherein the biometric device and the security device are operatively coupled.

A further understanding of the nature and the advantages of the inventions disclosed herein may be realized by reference of the remaining portions of the specification and the attached drawings.

### BRIEF DESCRIPTION OF THE DRAWINGS

FIG. 1 is a perspective view of a biometric security system according to one embodiment of the present invention.

FIG. 2 shows a perspective view of a security device locked and attached to a portable electronic device according to one embodiment of the present invention.

FIGS. 3A-3C illustrate a method of locking and unlocking a security device as it is being attached to and is being removed from a portable electronic.

FIG. 4 shows an embodiment of a capture device and a wireless module according to one embodiment.

FIG. 5 shows a system for actuating slot engagement member according to one embodiment of the present invention.

FIG. 6 depicts another embodiment a system for actuating slot engagement member according to one embodiment of the present invention.

FIG. 7 shows another technique of communicating with a wireless module according to one embodiment.

FIG. 8 depicts an added security feature for the security system according to one embodiment.

FIG. 9 shows an exploded view of some components of a locking device that can be used in embodiments of the invention.

FIG. 10 shows a perspective locking device according to one embodiment.

FIGS. 11A and 11B show the insertion of a locking device into the exterior wall of a piece of equipment.

### DETAILED DESCRIPTION OF THE INVENTION

Embodiments of the invention are directed to biometric security systems. “Biometrics” refers to technologies for measuring and analyzing human body characteristics, such as fingerprints, eye retinas and irises, voice patterns, facial patterns, and hand measurements. These measurements may be used for verification purposes. In embodiments of the invention, a biometric verification process may be used as a replacement for or used in conjunction with traditional security verification mechanisms such as passwords, combinations, and keys.

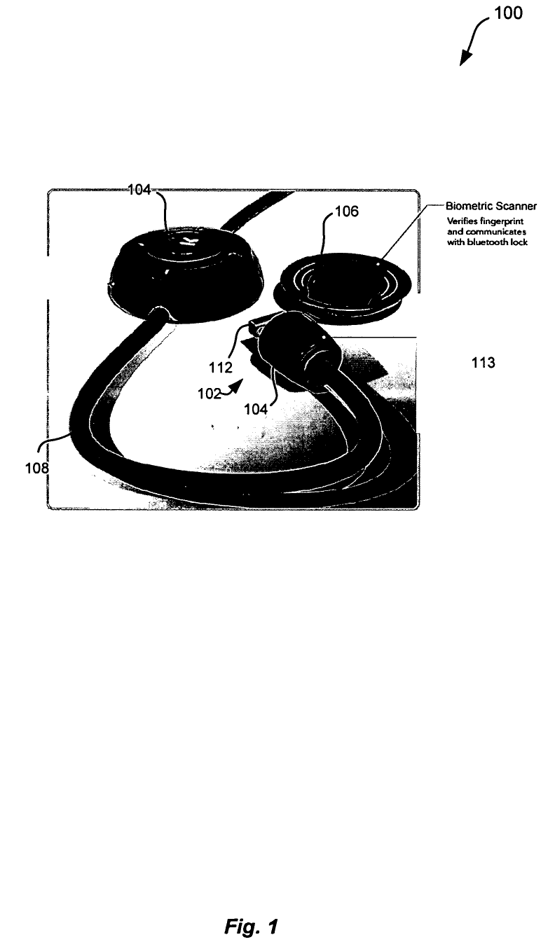

FIG. 1 depicts a biometric security system 100 according to one embodiment of the present invention. As shown, system 100 includes security device 102, a wireless module 104, a biometric device 106, and a cable 108.

In one embodiment, security device 102 is configured to be attached to a portable electronic device. Examples of portable electronic devices include laptop computers, desktop computers, personal digital assistants (PDAs), Blackberry devices, cellular phones, digital cameras, flat screen monitors, televisions, portable music players, etc.

In one embodiment, security device 102 is configured to be attached to a portable electronic device using a security slot that is present in a housing of the portable electronic device, or in a bracket attached to the portable electronic device. In embodiments of the invention, the portable electronic device has a slot associated with it. The slot can be formed in the housing of the portable electronic device or could be formed in a bracket or the like attached to the portable electronic device.

In one embodiment, the security slot may have dimensions of about 3 mm by about 7 mm and is generally rectangular in shape. A slot engagement member 112 associated with the security device 102 may be inserted into the security slot. For example, the slot engagement member may be in the form of a T-bar that has a profile that is complementary to the shape of the slot. Security device 102 is then secured to the portable electronic device via the security slot by misaligning the T-bar in the security slot such that removal of the T-bar from the difficult. For example, the T-bar may be rotated substantially 90 degrees after it is it is inserted into the slot. The process of securing security device 102 to a portable electronic device will be described in more detail below.

Biometric device 106 may include a biometric capture device 110 configured to receive a biometric identification from a user, and a verification module (not shown) configured to verify the biometric identification from the user.

Biometric device 106 is configured to authenticate a biometric identification received from the user. A biometric identification may be any identification for a user, such as fingerprints, eye retinas and irises, voice patterns, facial patterns, hand measurements, or other human characteristics.

In authenticating the user, biometric device 104 may verify the received biometric identification from the user to a stored biometric identification for the user. The verification may compare the received biometric identification to the stored biometric identification to determine if the received biometric identification substantially matches or does not match the stored biometric information. Using the verification system, only authorized users can unlock system 100. In some embodiments, many users may use system 100. A plurality of biometric identifications may be stored in a database accessible to the biometric device 104 so that a group of individuals may be authorized to use the system 100.

In one embodiment, biometric device 106 includes a biometric identification capture device 110. Capture device 110 is configured to capture the biometric identification from a user. For example, capture device 110 may be an optical scanner or solid-state sensor that is configured to scan a fingerprint, retina or iris, etc. of a user. Also, capture device 110 may capture audio waves, signatures, DNA, etc. mechanisms. Such capture devices are commercially available.

In a method according to an embodiment of the invention, a fingerprint scan is taken by capture device 110. This involves electronically obtaining a representation of a user's fingerprint. For example, a digital image is obtained by scanning a user's fingerprint. Alternatively, an ink impression of the user's fingerprint may be created on paper and then scanned by capture device 110. The scanned fingerprint is then digitized. Capture device 110 may use various mechanisms to detect ridges and valleys present in the fingerprint, such as optical Fourier Transform Infrared Spectroscopy (FTIR), thermal imaging, pressure-based imaging, ultrasound imaging, etc.

Once obtained, the captured digital image may then be compared with a stored digital image. The comparison may be preformed using many different techniques. For example, raised areas (e.g., ridges) and branches (e.g., bifurcations) in a human finger (image) may be compared. Various known algorithms may be used to determine if the received fingerprint image matches the stored fingerprint image.

It is expected that the biometric identification for a user may be substantially unique. Thus, a first biometric identification may be taken and stored. For example, a fingerprint image may be received for a user. It is expected that a user's fingerprint image may be substantially unique for that user. Thus, when capture device 110 captures a fingerprint image from a user, it can be compared to the stored fingerprint image to determine if the user using system 100 is authorized to use system 100. The stored fingerprint image and the captured fingerprint image may not match exactly but may be substantially similar such that it is determined that both fingerprint scans were scanned from the same fingerprint.

In one embodiment, the finger scanning technology used by capture device 110 may include electro-optical fingerprint recognition. A fingerprint is optically scanned directly from a user's finger and a resulting image is focused onto a small chip. The chip converts the focused image into a digital file that can be processed, and compared with other fingerprint images. The digital image may be high resolution and can be processed like any other scanned image, and thus, it is able to be quickly compared to stored fingerprint images.

Biometrics provide added security because it is hard to duplicate a biometric identification. For example, most likely, a fake fingerprint provided to capture device 110 is not verified using biometrics. This may be because of the intricacies of the ridges and branches found on a user's finger. Thus, added security is provided using system 100. It is expected that only a user who had previously stored a biometric identification in biometric device 106 may be able to lock and unlock security device 102.

After verification, biometric device 106 may send a verification result to wireless module 104. The result may be sent through any wireless communication link, such as through Bluetooth, 802.11(x), or any other wireless protocol. Although a wireless link is described, it will be recognized that any other link, such as a wired link, the Internet, or any other network may be used. In other embodiments, the biometric device and the security device may be in the same housing, so that a wired or wireless link would not be needed.

Wireless module 104 is configured to receive the verification result and can cause the slot engagement member associated with the security device 102 to move so that the locking device can be secured to the portable electronic device or removed from the portable electronic device. In one embodiment, wireless device 104 may be configured to lock or unlock security device 102 when a signal is received from biometric device 106. For example, if biometric device 106 does not verify the user, then a signal is not sent to wireless device 104 and thus no action is taken. However, if the user is verified, a signal is sent to biometric device 104, which causes biometric device 104 to perform an action, such as unlocking security device 102.

As shown, wireless module 104 is connected to security device 102 through a cable 108. When a verification result is received from biometric device 106, wireless module 104 is configured to actuate slot engagement member 112 of security device 102 through cable 108. For example, as will be described in more detail below, a cabling system may be used to lock/unlock security device 102. For example, security device 102 may have a locking head 113 that includes a slot engagement member 112, such as a T-bar where a crossmember of the T-bar can be misaligned with a slot such that removal of the T-bar from the slot is difficult.

Although wireless module 104 is shown as being separate from security device 102, it will be understood that wireless device 104 may be part of security device 102. Thus, wireless module 104 may lock and unlock security device 102 without using cable 108 to interact with security device 102.

In one embodiment, security device 102 may automatically be secured to a security slot of a portable electronic device when slot engagement member 112 is inserted into the security slot. A sensor may be provided in security device 102 that senses when slot engagement member 112 has been inserted into the security slot. At this point, slot engagement member 112 is misaligned to a position that thereby inhibits removal of slot engagement member 112 from the security slot. Security device 102 is extremely difficult to disengage by anyone not being verified using the biometric identification. Any unauthorized attempt to remove security device 102 from the portable electronic device will most likely result in significant damage to the housing, making the portable electronic device difficult to resell and greatly reducing its theft potential.

Although automatic locking is described, it will be understood that a user may be required to have a biometric identification verified by biometric device 106 in order to lock security device 102 to the security slot. This verification may be sent to wireless module 104, which can then secure security device 102 to the security slot. Then, a second scan of the biometric identification for the user may be required in order to unlock security device 102 from the security slot of the portable electronic device.

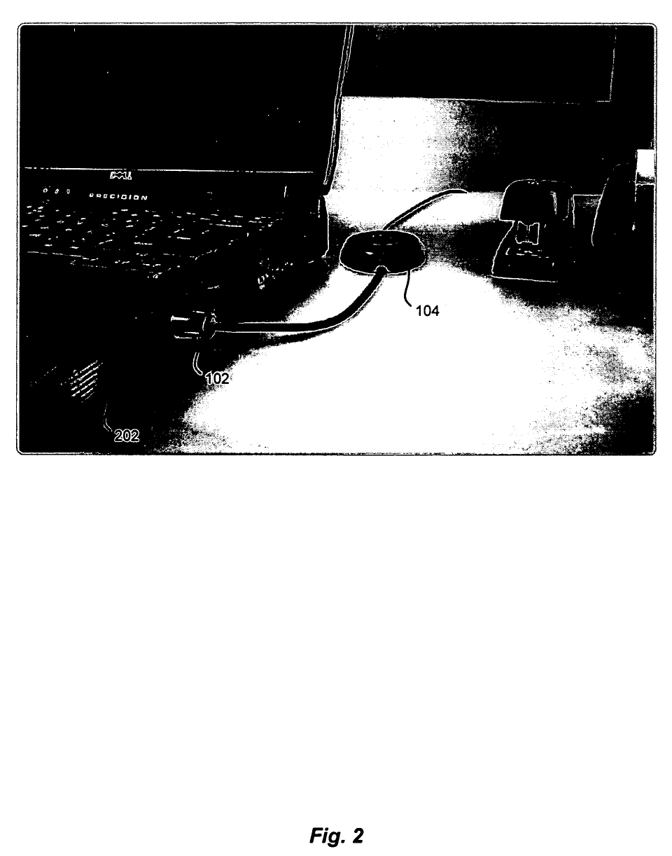

FIG. 2 shows security device 102 being in a locked state in a portable electronic device 202 according to one embodiment of the present invention. As shown, security device 102 has a slot engagement member (not shown) that has been inserted in a security slot of portable electronic device 202. Slot engagement member 112 may then be misaligned such that it inhibits the removal of slot engagement member from the security slot.

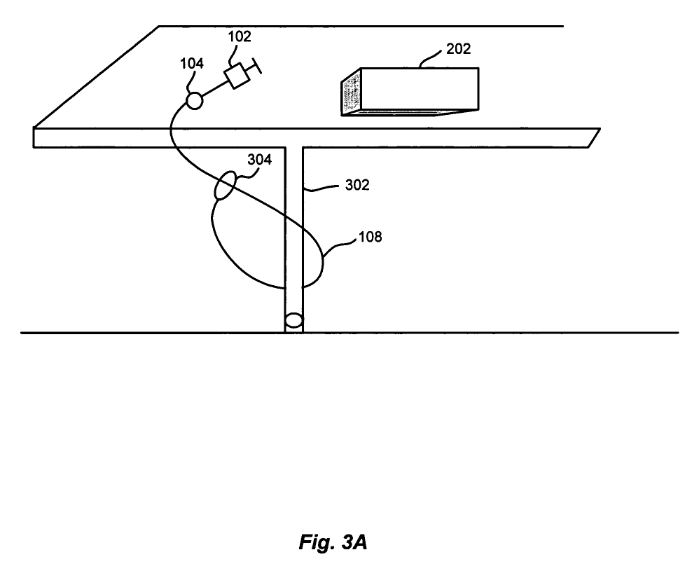

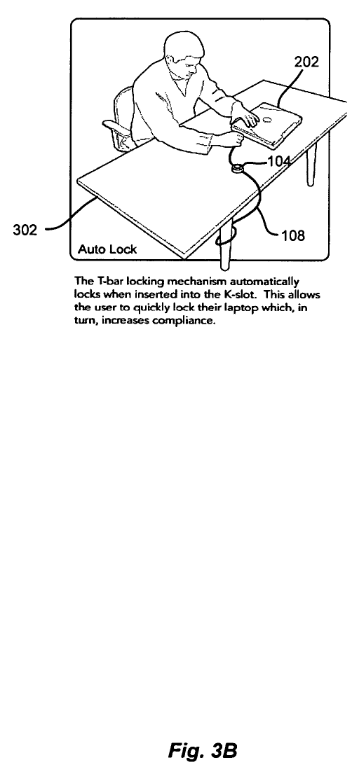

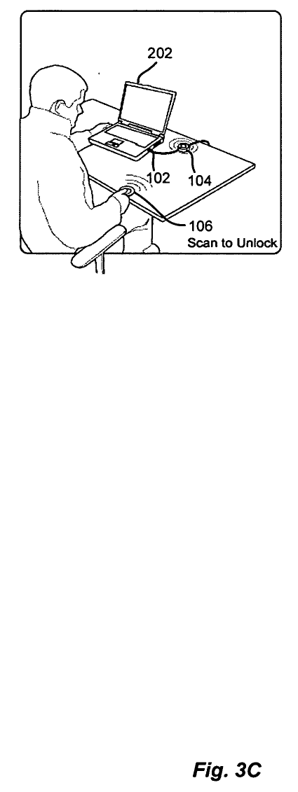

FIGS. 3A-3C illustrate a method for securing a security device 102 to portable electronic device 202 or removing it from the portable electronic device 202. As shown in FIG. 3A, cable 108 may be looped around an apparatus 302. Apparatus 302 may be any object, such as a table, handle, chair, etc. In one embodiment, apparatus 302 is substantially stationary in that it is hard to move. For example, a desk leg may be bolted down to a floor. Thus, when cable 108 is looped around apparatus 302 and through loop 304, the movement of system 100 is inhibited. For example, security device 102 cannot be moved farther than substantially the length of cable 108 because it has been looped around apparatus 302.

FIG. 3B shows a user inserting a slot engagement member 112 of a security device 102 into a security slot of portable electronic device 202. In one embodiment, security device 102 is automatically locked to the security slot when slot engagement member 112 is inserted into the slot of portable electronic device 202. For example, slot engagement member 112 may be automatically turned so that it is misaligned with the slot after it is inserted into the security slot. Thus, removal of slot engagement member 112 from the security slot is difficult. Automatic locking may be useful because the user has to perform fewer steps to quickly lock a portable electronic device 202. Further, this may increase the likelihood that a user will lock a portable electronic device 202 because of the automatic step.

A user may then use portable electronic device 202 and at some point and may decide to unlock security device 102. FIG. 3C shows a user unlocking security device 102 using biometric device 106. As shown, biometric device 106 has been placed within an area of wireless module 104. For example, biometric device 106 has been placed on a desktop of stationary object 302. In some embodiments, the distance that biometric device 106 may be apart from wireless device 104 depends on the wireless technology used to communicate between the devices. For example, if Bluetooth is used to communicate the verification result, then biometric device 106 may be placed within thirty or so feet of wireless module 104.

As shown, a user places a finger on biometric identification capture device 110. Although a fingerprint scan is shown, it will be understood that other biometric identifications may be taken, such as iris scans, handwriting samples, etc. Capture device 110 is configured to scan the user's fingerprint and determine a biometric identification. The biometric identification is then verified. For example, a biometric identification is compared to a stored biometric identification to determine if they substantially match. If they substantially match, the user identity may be verified and the verification result is sent to wireless module 104.

Wireless module 104 is then configured to automatically unlock security device 102 so that it can be separated from portable electronic device 202. For example, slot engagement member 112 may be turned such that movement from the security slot is not inhibited. The user may remove security device 102 from the security slot.

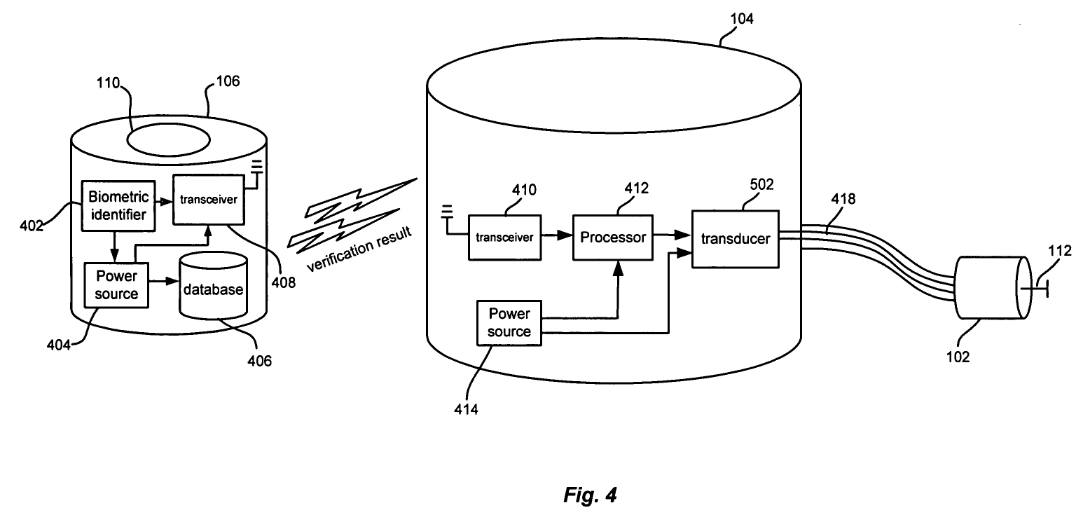

FIG. 4 shows an embodiment of a biometric device 106 and a wireless module 104 according to one embodiment. As shown, biometric device 106 includes a biometric identifier 402, a processor 404, a database 406, and a transceiver 408.

Biometric identifier 402 is configured to receive captured information from capture device 110. Biometric identifier 402 is then configured to determine a biometric identification from the information received from capture device 110. For example, a fingerprint may be scanned for capture device 110. Biometric identifier 402 is configured to produce a digital image of the fingerprint. The biometric identification is then sent to processor 404.

Processor 404 is configured to verify the received biometric identification. In one embodiment, a biometric identification has been stored in database 406. The received biometric identification is verified against the stored biometric identification. In one embodiment, if it is determined that the received biometric identification substantially matches the stored biometric identification, then the user is verified.

Processor 404 then sends a verification result to transceiver 408. In one embodiment, if the user is not verified, then processor 404 does not send any signals to transceiver 408 for transmission to wireless module 104. In another embodiment, processor 104 may cause transceiver 108 to send an indication that the verification failed. Wireless module 104 may output an indication that the verification failed in this case.

If the biometric identification is verified, transceiver 408 is then configured to transmit the verification result to wireless module 104. As mentioned above, the result may be transmitted through a wireless communication link, such as a Bluetooth, 802.11(x), etc.

As shown, wireless module 104 includes another transceiver 408, processor 412, power source 414, and transducer 502.

Transceiver 408 receives the verification result from transceiver 408 and forwards it to processor 412. Processor 412 is then configured to determine an action to perform. For example, when the verification result is received, processor 412 may send a signal to transducer 502 to unlock security device 102 (if the verification result indicates the biometric identification was verified). This may be the case when security device 102 is automatically secured to the security slot when it is inserted into the slot.

In other embodiments, processor 412 may decide whether to unlock or lock security device 102. For example, processor 412 may store a state of locking device 412 (i.e., if it is unlocked or locked). Processor 412 is then configured to send a signal to transducer 502 that indicates whether security device 102 should be locked or unlocked based on the current state. For example, if the current state is locked, then the signal indicates that security device 102 should be unlocked.

Transducer 502 is configured to unlock security device 102. In one embodiment, a power source 414 is used to power transducer 502. Power source 414 may be derived from many sources. For example, power source 414 may be derived from standalone batteries, an outlet providing a DC or AC current, or from portable electronic device 202 (e.g., from a universal serial bus (USB) port).

Transducer 502 is then configured to actuate an inner cable 418 that causes slot engagement member 112 to turn. The actuation of may cause slot engagement member 112 to lock/unlock to/from portable electronic device 202. The operation of transducer 502 and inner cable 418 may be described in more detail below.

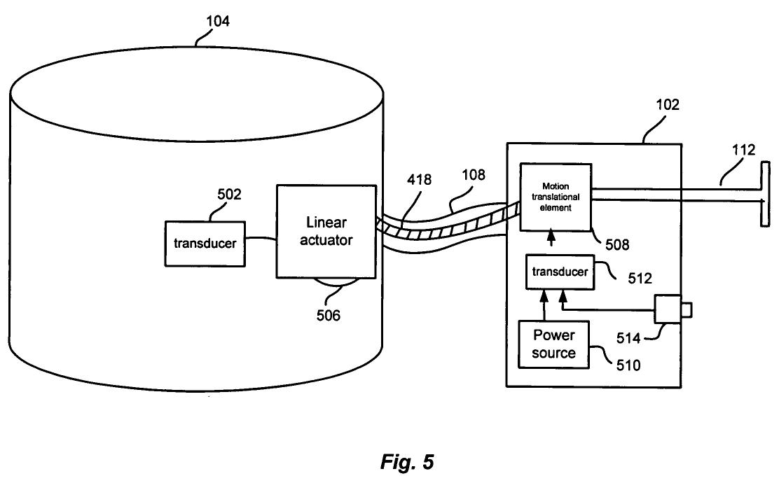

FIG. 5 shows a system for actuating slot engagement member 112 according to one embodiment of the present invention. As shown, wireless module 104 includes a transducer 502 and a linear actuator 506. Security device 102 includes a motion translational element 508. Transducer 502 receives a power signal from power source 414 and to transform it into mechanical energy.

Transducer 502 then moves a linear actuator 506. In one embodiment, linear actuator may include a gear that is powered by a motor that may move cable 418.

As shown, inner cable 418 is connected to linear actuator 506 through a cable 108 in a flexible manner to linear actuator 506. When linear actuator 506 is rotated, cable 418 may be pulled back towards wireless module 104 or it may be extended from wireless module 104. In this way, slot engagement member 112 may be rotated in a clockwise and counterclockwise manner. For example, slot engagement member 112 may be in a first position, such as a horizontal position. Inner cable 418 is connected to a motion translational element 516, which is configured to automatically turn slot engagement member 112. For example, a gear may be turned in a counterclockwise manner. Accordingly, slot engagement member 112 may be turned in a counterclockwise manner. Also, if lock head is a hook, the hook may be pivoted. When slot engagement member 112 is turned in a counterclockwise manner, it may be secured within security slot and movement from the security slot may be inhibited.

When slot engagement member 112 should be unlocked, cable 418 may be extended from wireless module 104 using linear actuator 506. By extending cable 418, motion translational element 516 causes slot engagement member 112 to turn. When slot engagement member 112 is turned in a clockwise manner, it may become flush with security slot and movement from the security slot may be allowed. Accordingly, automatic locking and unlocking of security device 102 is provided.

The unlocking and locking of security device 102 is provided through a flexible cable 108. Cable 108 may be flexible because a user has to bend the cable in order to secure it to an object 302, as described in FIG. 3A. The system shown in FIG. 5 allows the locking and unlocking of security device 102 through a flexible cable.

In another embodiment, slot engagement member 112 may be rotated using a power source 510 and transducer 512 that are provided in security device 102. The power source may device its power from wireless module 104 or it may derive its own power through batteries, a USB port, or an external source.

Power source 510 is configured to cause transducer 512 to actuate motion translational element 508. In one embodiment, when a sensor 514 detects that slot engagement member 112 has been inserted into a security slot, sensor 514 causes transducer 512 to turn motion translational element 508. Accordingly, slot engagement member 112 may be turned to secure it to portable electronic device 202. Accordingly, automatic locking may be provided.

Wireless module 104, when it receives the verification result, may then unlock slot engagement member 112. This may be done by sending a signal to transducer 512 through inner cable 418. Also, slot engagement member 112 may then be unlocked using inner cable 418 as described above.

FIG. 6 depicts another embodiment a system for actuating slot engagement member 112 according to one embodiment of the present invention. In this embodiment, wireless module 104 may be included in security device 102. As shown, wireless module 104 includes a transceiver 408, processor 412, power source 414, and transducer 502.

Transceiver 408 receives the verification result from transceiver 408 and forwards it to processor 412. Processor 412 is then configured to determine an action to perform. For example, when the verification result is received, processor 412 may cause security device 102 to unlock by turning slot engagement member 112 such that it can be removed from the security slot. This may be the case when security device 102 is automatically locked to the security slot when it is inserted into the slot.

In other embodiments, processor 412 may decide whether to unlock or lock security device 102. For example, processor 412 may store the state of locking device 412 (i.e., if it is unlocked or locked). Processor 412 is then configured to send a signal to transducer 502 that indicates whether security device 102 should be locked or unlocked based on the current state. For example, if the current state is locked, then the signal indicates that security device 102 should be unlocked.

Transducer 502 is configured to unlock security device 102. In one embodiment, a power source 414 is used to power transducer 502. Power source 414 may be derived from many sources.

Transducer 502 is configured to receive a power signal from power source 414 and to transform it into a form usable by a motor. Transducer 502 is then configured to turn when powered by motor 504.

Slot engagement member 112 may be rotated in a clockwise and counterclockwise manner. For example, slot engagement member 112 may be in a first position, such as a horizontal position. Accordingly, slot engagement member 112 may be turned in a counterclockwise manner. When slot engagement member 112 is turned in a counterclockwise manner, it may be misaligned within the security slot and movement from the security slot may be difficult.

When slot engagement member 112 should be unlocked, a gear may be automatically turned using transducer 502. For example, a gear may be turned in a clockwise manner causing slot engagement member 112 to turn. When slot engagement member 112 is turned in a clockwise manner, it may become flush with the security slot and slot engagement member 112 may be removed from the security slot. Accordingly, automatic locking and unlocking of security device 102 is provided.

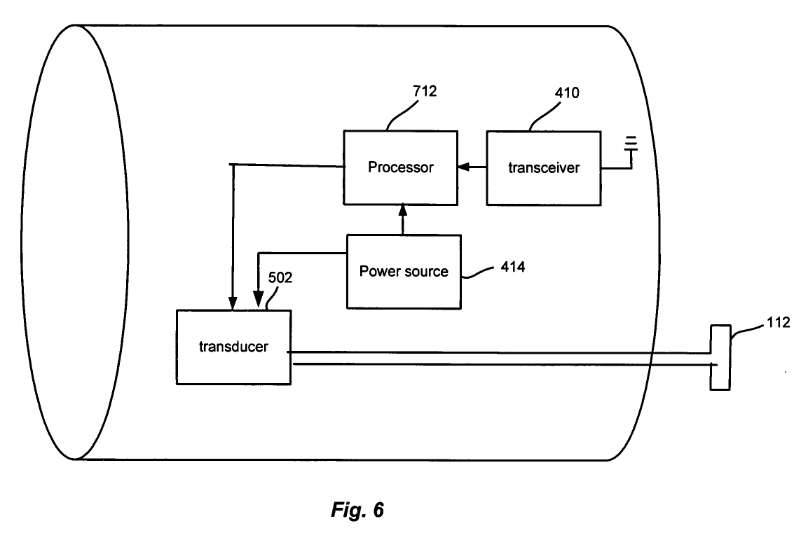

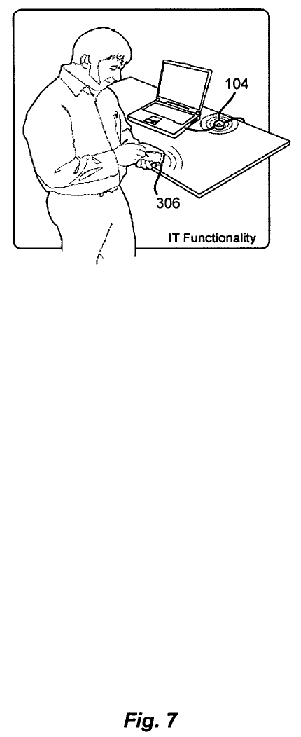

FIG. 7 shows another technique of communicating with wireless module 104 according to one embodiment. As shown, a personal digital assistant (PDA) 306 is used to communicate with wireless module 104. In one embodiment, personal digital assistant 306 may include a capture device 110 that captures a biometric identification from the user. PDA 306 may then communicate with security device 102 as described above with respect to biometric device 106. Although a PDA is described, other devices may be used to communicate with wireless module 104, such as a cellular phone, remote control, etc.

PDA 306 may also allow the user to perform other administrative functions. For example, PDA 306 may allow the user to check the status of security device 102. The user may determine if security device 102 is in a locked or unlocked state. Further, if the lock has been violated in some way, PDA 306 may be notified by wireless module 104. For example, a phone call may be placed to a user's cellular phone.

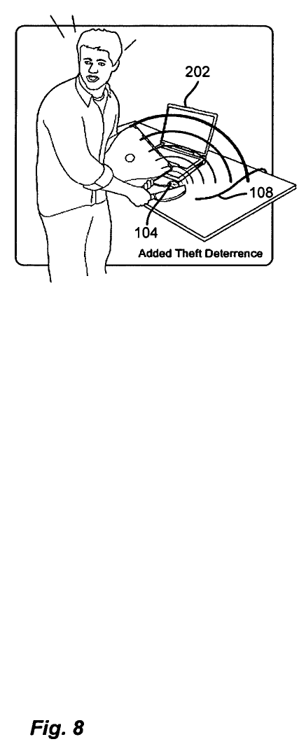

FIG. 8 depicts an added security feature for security system 400 according to one embodiment. In one embodiment, if cable 108 is cut, an audible alarm may be signaled from wireless module 104. This may deter theft in that a potential thief may not take portable electronic device 202 when the alarm is heard. Rather, the thief may potentially leave the premises and not take portable electronic device 202.

Embodiments of the present invention provide many advantages. For example, using a biometric identification, the security provided by system 100 may be very reliable. Biometrics provides a secure system where most likely only a single user can unlock the security device. Also, automatic locking and unlocking is provided by system 100. Thus, users can perform fewer steps in locking and unlocking a lock. Thus, the use of the lock security device is easier and more convenient.

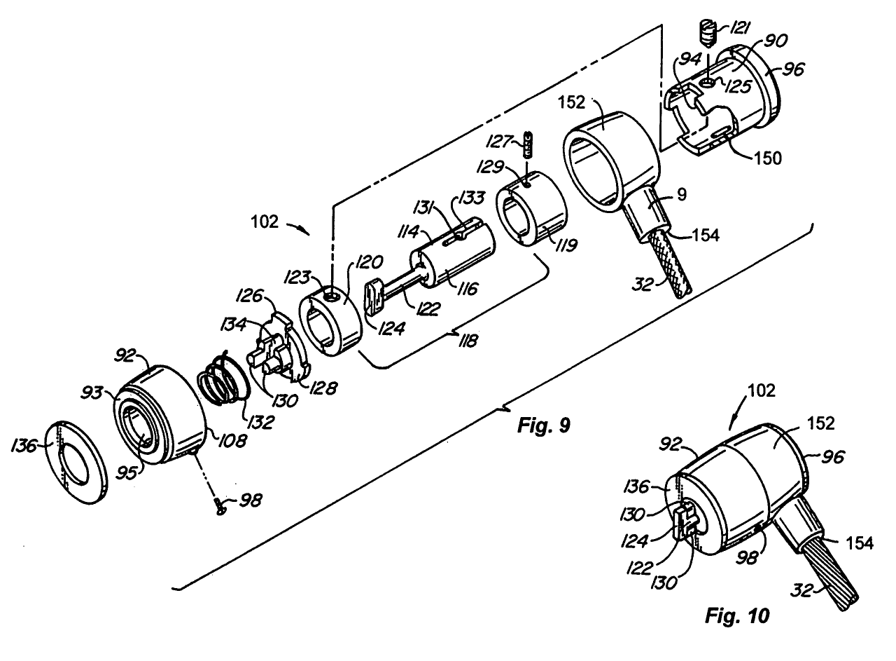

Different embodiments of security devices 102 will now be described. Security device 102 may be provided in many forms. A suitable security device 102 is shown in FIG. 10 and the exploded view of FIG. 9. Security device 102 includes a hollow shell 90 and a nose-piece 92 which, in combination, form a housing. Shell 90 has a hollow cylindrical interior cavity 94, and an integral apertured plate 96 at one end. A pin 98 is inserted through an aperture (not shown) in nose-piece 92 to engage a slot 150 in shell 90. Pin 98 is designed to shear when torque is applied to nose-piece 92 so that an unauthorized attempt to remove the attachment mechanism will simply shear the pin and allow the nose-piece to freely rotate without degrading the attachment of the locking device to the component to be protected. Slot 150 is axially elongate so that limited axial movement is allowed between shell 90 and nose-piece 92. The forward end of nose-piece 92 has a plate 93 having a central aperture 95.

A cylindrical collar 152 circumscribes the outer portion of shell 90 and occupies the slot laterally defined by plate 96 and the aft surface 108 of nose-piece 92. Collar 152 has an integral tab 156 with an aperture 154 adapted to receive one end of cable 32. Cable 32 is dead-ended into tab 156 and attached so that it cannot be removed.

Slot engagement member 112 includes a spindle 114, which has a cylindrical portion 116 adapted to be received within a cylindrical lock 118 in shell 90. Cylindrical lock 118 includes a front cylinder 119, and a back cylinder 120. A blunt pin or set screw 121 is inserted through an aperture 125 in shell 90, and through a corresponding aperture 123 in back cylinder 120, to lock the front cylinder rotationally with respect to shell 90. Correspondingly, pin or set screw 127 engages a relatively smaller aperture 129 in front cylinder 119, and a widening 131 in slot 133 in the cylindrical portion 116 of spindle 114. Front cylinder 119 is thus fixed rotationally With respect to spindle 114.

As with conventional cylindrical locks, a plurality of pins normally span the interface between front cylinder 119 and back cylinder 120 so that the cylinders are rotationally locked together, thus preventing relative rotation between locking shell 90 and spindle 114. Spindle 114 can be rotated with respect to shell 90 upon receiving a verification of a biometric identification.

Spindle 114 also includes a shaft 122, and a crossmember 124 at the free end of the shaft. An abutment mechanism 126 has an abutment plate 128 adapted to fit within nose-piece 92, and a pair of pins 130 adapted to extend outwardly through aperture 95. A spring 132 is located between abutment plate 128 and nose-piece 92 to bias the cylindrical portion 116 of spindle 114 and the abutment plate rearwardly. Abutment plate 126 has an elongate aperture 134 which allows crossmember 124 to extend through the aperture plate. A plastic bushing 136 is fixed to the surface of plate 93 so that the mechanism does not scar the equipment to which it is attached.

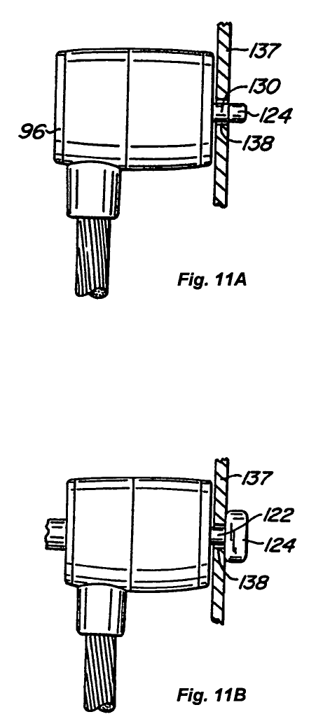

The insertion of security device 102 into the exterior wall 137 of a piece of equipment is illustrated by way of reference to FIGS. 11A and 11B. Wall 136 has a slot 138. The peripheral dimensions of crossmember 124, and also those of pins 130 and shaft 122 in combination, is that the crossmember is generally rectangular, having straight sides and semi-circular ends. In the preferred embodiment, the long dimension of the crossmember 124 is 6.75 millimeters, while the short dimension is 2.75 millimeters, each being slightly less than the corresponding dimension of slot 138. The peripheral dimensions of the pins 130 and shaft 122 also closely conform to the interior dimensions of slot 138. As with crossmember 124, pins 130 in shaft 122 have a long dimension of 6.75 millimeters, and a short dimension of 2.75 millimeters.

As illustrated in FIG. 11A, crossmember 124 is aligned with pins 30 so that the crossmember can be inserted into slot 138. When fully inserted, the space in the slot is essentially occupied by pins 130 and shaft 122. If necessary, plate 96 can be depressed to push the cylindrical portion of spindle 114 against spring 132. Once crossmember 124 has been fully inserted through slot 138, wireless module 104 is used to rotate the spindle 90 degrees and misalign crossmember 124 in slot 138.

In operation, security device 102 is attached to an item of computer or other equipment which has a specially designed slot 138. First, the crossmember 124 is aligned with the pins 130, for insertion to the crossmember through the slot. The spindle 114 is then rotated relative to the housing to misalign the crossmember 124 relative to the slot. The spindle is locked in this configuration using wireless module 104. The locking device is extremely difficult to disengage by anyone not having the appropriate biometric identification. Any unauthorized attempt to remove the locking device from the computer component will most likely result in significant damage to the computer housing, making the computer difficult to resell and greatly reducing its theft potential.

Other embodiments of security device 102 are further described in U.S. Pat. No. 6,006,557 and U.S. Pat. No. 5,502,989. Also, in another example, in U.S. Pat. No. 6,321,579, a security device 102 may include tabs and a hook arm. The tabs and hook arm are configured to be inserted into a slot. Once inserted into the slot, the hook arm may be pivoted such that it latches onto an inside surface of the slot. Accordingly, the locking device is secured within the slot and cannot be removed. Another locking device is described in U.S. Pat. No. 6,591,642. This locking device includes an L-shaped hook that is inserted into a security slot in a portable electronic device. A user then pushes a button or cylinder at the end of the device to push out a bolt to fill the security slot and thereby secure the locking device to the portable electronic device.

In order to unlock the locking device, the hook arm is pivoted in an opposite direction such that the hook arm is unlatched from the inside surface of the slot. The locking device may then be removed.

Embodiments of the present invention may be implemented in the form of control logic in software or hardware or a combination of both. The control logic may be stored in an information storage medium as a plurality of instructions adapted to direct an information-processing device to perform a set of steps disclosed in embodiments of the present invention. Examples of information storage media include random access memory (RAM), read only memory (ROM), persistent (non-volatile) storage, hard disk drives, floppy disk drives along with associated removable media, Compact Disc Read Only Memory (CD-ROMs), removable media cartridges, and other computer readable media. Examples of information-processing devices include personal computers, portable computers, workstations, network computers, mainframes, kiosks, or any other data processing systems.

The above description is illustrative but not restrictive. Many variations of embodiments of the present invention will become apparent to those skilled in the art upon review of the disclosure. Based on the disclosure and teachings provided herein, a person of ordinary skill in the art will appreciate other ways and/or methods to implement embodiments of the present invention. The scope of the invention should, therefore, be determined not with reference to the above description, but instead should be determined with reference to the pending claims along with their full scope of equivalents.

What is claimed is:

1. A biometric security system for securing a portable electronic device including a slot associated with the portable electronic device, the biometric security system comprising:
a security device including a slot engagement member, wherein the slot engagement member is sized to enter the slot;
a biometric device configured to receive a biometric identification from a user and configured to determine a verification result based on received biometric identification with a stored biometric identification for the user, wherein the biometric device is operatively coupled to the security device; and
a transducer operatively coupled to the security device and the biometric device, wherein the transducer is capable of actuating the slot engagement member.

2. The biometric security system of claim 1, wherein the slot is a security slot.

3. The biometric security system of claim 2, further comprising a wireless module operatively coupled to the transducer.

4. The biometric security system of claim 1, wherein the security device further comprises a pair of pins and wherein the slot engagement member is between the pair of pins.

5. The biometric security system of claim 1, wherein the portable electronic device is a portable computer.

6. The biometric security system of claim 1, wherein the security device includes a flexible cable coupling the biometric device to the slot engagement member.

7. The biometric security system of claim 6, wherein the security device and the biometric device are housed within the same housing.

8. The biometric security system of claim 1, wherein the biometric device and the security device communicate via a wireless link that comprises a Bluetooth connection.

9. The biometric security system of claim 1, wherein the biometric device comprises a fingerprint scanner.

10. A method for securing a portable electronic device, the method comprising:
receiving a biometric identification from a user;
verifying the biometric identification; and
after verifying the biometric identification, moving a slot engagement member within a slot associated with the portable electronic device such that the slot engagement member cannot be withdrawn from the slot.

11. The method of claim 10, wherein the portable electronic device is a portable computer.

12. The method of claim 11, further comprising after verifying the biometric identification, moving the slot engagement member within the slot in a portable electronic device such that the slot engagement member can be withdrawn from the slot.

13. The method of claim 10, further comprising transmitting a signal to a transducer through a wireless communication medium after verifying, and then using the transducer to move the slot engagement member.

14. The method of claim 10, wherein the slot engagement member is between a pair of pins when the slot engagement member engages the slot.

15. The method of claim 10, wherein the slot is a security slot.

16. The method of claim 10, further comprising using a transducer coupled to the slot engagement member to move the slot engagement member.

17. The method of claim 10, wherein the slot engagement member rotates.

18. The method of claim 10, wherein the biometric device comprises a fingerprint or iris scanner, wherein the received biometric identification comprises a fingerprint or iris image.

19. A system comprising:
a portable electronic device including a security slot associated with the portable electronic device;
a security device configured to attach to the portable electronic device via the security slot; and
a biometric device configured to receive a biometric identification from a user and configured to determine a verification result based on received biometric identification with a stored biometric identification for the user,
wherein the biometric device and the security device are operatively coupled.

20. The system of claim 19, wherein the security slot has dimensions of about 3 mm by about 7 mm.
